(19) United States
(12) Patent Application Publication
(10) Pub. No.: US 2010/0108185 A1
(43) Pub. Date: May 6, 2010

(54) Air compressor and tire repairing combination

(76) Inventor: Wen San Chou, Tainan Hsien (TW)

Correspondence Address: CHARLES E. BAXLEY, ESQUIRE, 90 JOHN STREET, SUITE 309, NEW YORK, NY, 10038, US

(21) Appl. No.: 12/290,795

(22) Filed: Nov. 4, 2008

(51) Int. Cl. B29C 73/02; F04B 35/04; B29C 73/16; B67C 3/00

(52) U.S. Cl. 141/38; 141/67; 417/415

(57) ABSTRACT

An air compressor and tire repairing combination includes an air compressing device for generating a pressurized air, a tire repairing device having a container for receiving a repair liquid, and a tubular member having a bore for receiving the pressurized air and having an inlet port coupled to the air compressing device for receiving the pressurized air, and having an outlet port for supplying the pressurized air out through a nozzle, and having an exit for selectively supplying the pressurized air to the container and to selectively force the repair liquid to flow out of the container and into a faulty tire and to repair and to inflate the faulty tire simultaneously.

### BACKGROUND OF THE INVENTION

1. Field of the Invention

The present invention relates to an air compressor and tire repairing combination, and more particularly to an air compressor and tire repairing combination including a control device for selectively switching or actuating an air compressing device or compressor to generate and supply an air flow or a pressurized to inflate various air facilities, and for selectively switching or actuating and injecting a repair liquid into the faulty tire and to repair and to inflate the faulty tire simultaneously.

2. Description of the Prior Art

Typical air compressing devices comprise a fan device rotatably received in a compressor housing, and a motor coupled to the fan device for driving or rotating the fan device to generate and supply a pressurized air and to inflate various air facilities, such as tires, air beds, air cushions, hovercrafts, etc. The other typical air compressing devices comprise a piston slidably received in a cylinder housing, and a motor coupled to the piston for moving the piston relative to the cylinder housing in a reciprocating action, in order to generate a pressurized air of a greater air pressure and a decreased flowing quantity.

The applicant has developed various kinds of typical air compressing devices each also comprising a motor coupled to a piston that is slidably received in a cylinder housing for moving the piston relative to the cylinder housing in a reciprocating action, in order to generate a pressurized air of a greater air pressure and a decreased flowing quantity. One example of the typical air compressing devices is disclosed in U.S. Pat. No. 7,240,642 to Chou.

However, the typical air compressing devices may only be used to generate and supply the pressurized air to inflate the air facilities, but may not be used to repair the faulty vehicle tires.

U.S. Pat. No. 6,283,172 to Thurner discloses one of the typical devices for repairing a tire fault and comprising a pressurized gas source coupled to a replaceable and compressible liquid storage volume for supplying the pressurized gas to force and to inject the liquid out of the storage volume and to repair the faulty tires.

However, the pressurized gas may only be used to repair the faulty tires, but may not be used to inflate the air facilities, such as the tires, the air beds, the air cushions, the hovercrafts or the like, such that the users have to purchase and prepare another air compressing device to inflate various air facilities.

U.S. Pat. No. 6,345,650 to Paasch et al. discloses another typical tire repairing device for acting as a readily available bridge to connect a deflated tire with an inflated tire.

However, after the deflated tire is inflated by the inflated tire, the inflated tire or both the tires will be deflated, and the users have to purchase and prepare another air compressing device to inflate the deflated tire, such that the typical tire repairing device is inconvenient to repair the deflated tire.

The present invention has arisen to mitigate and/or obviate the afore-described disadvantages of the conventional air compressor and tire repairing combinations.

### SUMMARY OF THE INVENTION

The primary objective of the present invention is to provide an air compressor and tire repairing combination including a control device for selectively switching or actuating an air compressing device or compressor to generate and supply an air flow or a pressurized air to inflate various air facilities, and for selectively switching or actuating and injecting a repair liquid into the faulty tire, and in order to repair and to inflate the faulty tire simultaneously.

In accordance with one aspect of the invention, there is provided an air compressor and tire repairing combination comprising an air compressing device for generating and supplying a pressurized air, and including an outlet tube for supplying out the pressurized gas, a tire repairing device including a container having a chamber formed therein for receiving a repair liquid and for selectively supplying the repair liquid to a faulty tire, and a controlling device including a tubular member having a bore formed therein, and having an inlet port coupled to the outlet tube of the air compressing device for receiving the pressurized air from the outlet tube of the air compressing device, and having an outlet port coupled to a nozzle for selectively supplying the pressurized air out through the nozzle, and having an exit coupled to the container for selectively supplying the pressurized air to the container and to selectively force the repair liquid to flow out of the container and to repair and to inflate the faulty tire simultaneously.

The tubular member includes a valve seat provided in the tubular member and disposed between the inlet port and the outlet port of the tubular member for selectively closing or blocking the outlet port and for selectively controlling and supplying the pressurized air to flow out or not to flow out through the outlet port and the nozzle.

The controlling device includes a valve stem slidably received and engaged in the bore of the tubular member and having a valve member for selectively engaging with the valve seat of the tubular member and for selectively blocking the outlet port of the tubular member.

The tubular member includes a valve seat provided in the tubular member and disposed between the inlet port and the exit of the tubular member for selectively controlling and supplying the pressurized air out through the exit and the container of the tire repairing device.

The controlling device includes a valve stem slidably received and engaged in the bore of the tubular member and having a valve member provided on the valve stem for selectively engaging with the valve seat of the tubular member and for selectively blocking the exit of the tubular member.

The controlling device includes a spring member engaged with the valve stem for biasing and forcing the valve member of the valve stem to engage with the valve seat of the tubular member and to selectively block the exit of the tubular member and to prevent the pressurized air from flowing out through the exit of the tubular member and from flowing to the container of the tire repairing device.

The tubular member includes a stop provided therein, and the valve stem includes a protrusion extended from the valve stem and engageable with the stop when the valve stem is depressed against or onto the spring member and when the valve stem is rotated relative to the tubular member, in order to maintain the valve member of the valve stem in engagement with the valve seat of the tubular member.

The valve stem includes a latch extended outwardly and upwardly extended from the upper portion of the valve stem and engageable with the stop for limiting the valve stem to slide relative to the tubular member.

The tubular member includes a compartment formed in an upper casing, and a knob is provided on top of the valve stem and slidably engaged in the compartment of the casing of the tubular member for depressing and moving the valve stem onto the spring member.

The casing includes a space formed therein for selectively receiving the protrusion of the valve stem, and the stop is extended into the casing and located between the space and the compartment of the casing.

The air compressing device includes a cylinder housing, a piston slidably engaged in the cylinder housing, a piston rod extended from the piston, and a motor attached to the cylinder housing and coupled to the piston rod with an eccentric or gear coupling device for moving the piston relative to the cylinder housing in a reciprocating action, in order to generate the pressurized air.

The tubular member includes a mouth communicating with the bore of the tubular member and coupled to a pressure gauge for detecting and displaying or showing an air pressure in the bore of the tubular member.

The container includes a mouth, a cap is detachably attached to the mouth of the container with a threading engagement, and includes a block engaged into the mouth of the container, and includes an inlet port coupled to the exit of the tubular member for selectively receiving the pressurized air from the tubular member, and includes an inlet passage formed therein and communicating with the inlet port for allowing the pressurized air to selectively flow into the chamber of the container and to force the repair liquid to flow out of the container.

The cap includes an outlet passage formed therein and offset from the inlet passage of the cap and communicating with an outlet port which is coupled to a nozzle for allowing the pressurized air to force the repair liquid in the container to flow out through the outlet passage and the outlet port and to flow to the nozzle.

A lid is further provided and detachably engaged onto the block of the cap for selectively blocking or closing or sealing the outlet passage and the inlet passage of the cap and for preventing the repair liquid from flowing out through the outlet passage and the outlet port of the cap.

The lid includes a catch extended therefrom for removably engaging with the outlet passage of the cap and for detachably attaching the lid to the block of the cap, and the lid is disengageable from the block and movable into the chamber of the container when the pressurized air is supplied into the inlet port and the inlet passage of the cap.

The cap includes a compartment formed in the lower portion thereof and communicating with the outlet passage of the cap for allowing the repair liquid to be completely flown out of the container. A receptacle is further provided and includes a chamber formed therein for receiving the air compressing device and the tire repairing device and the controlling device.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of an air compressor and tire repairing combination in accordance with the present invention;

FIG. 2 is a bottom plan schematic view of the air compressor and tire repairing combination;

FIG. 3 is another bottom plan schematic view of the air compressor and tire repairing combination, in which a lower housing member or a back cover has been removed for showing the inner structure of the air compressor and tire repairing combination;

FIG. 4 is a further bottom plan schematic view similar to FIG. 3, in which a portion of the air compressor and tire repairing combination has been cutoff for showing the inner structure of the air compressor and tire repairing combination;

FIG. 5 is a partial perspective view of the air compressor and tire repairing combination, in which a portion of the air compressor and tire repairing combination has been cutoff or removed for illustrating the inner structure of the air compressor and tire repairing combination;

FIG. 6 is a further partial perspective view similar to FIG. 5, illustrating the operation of the air compressor and tire repairing combination;

FIG. 7 is a still further partial perspective view illustrating a control device of the air compressor and tire repairing combination; and

FIG. 8 is a still further partial perspective view similar to FIG. 7, illustrating the operation of the air compressor and tire repairing combination.

### DETAILED DESCRIPTION OF THE PREFERRED EMBODIMENT

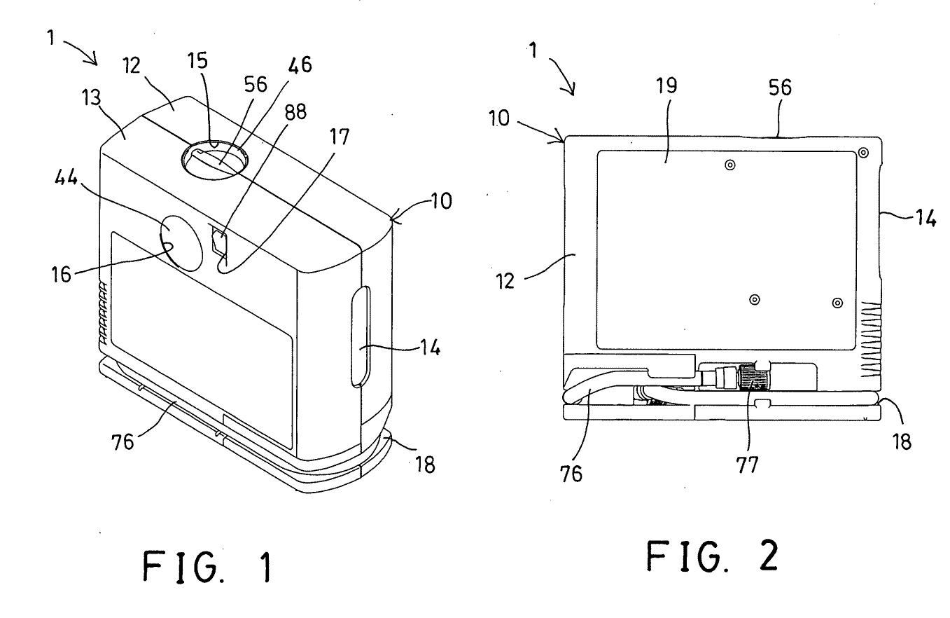

Referring to the drawings, and initially to FIGS. 1-5, an air compressor and tire repairing combination 1 in accordance with the present invention comprises an outer receptacle 10 including a chamber 11 formed therein and formed or defined by a lower receptacle member 12 and an upper receptacle member 13, the receptacle 10 includes a side opening 14 formed in one side portion thereof, an upper opening 15 formed in the upper portion thereof, two front openings 16, 17 formed in the front portion thereof, and a peripheral recess 18 formed in the outer peripheral portion of the bottom portion thereof, and a cover 19 openably attached and secured to the lower receptacle member 12 of the receptacle 10 for covering or shielding or protecting the parts and elements received in the chamber 11 of the receptacle 10.

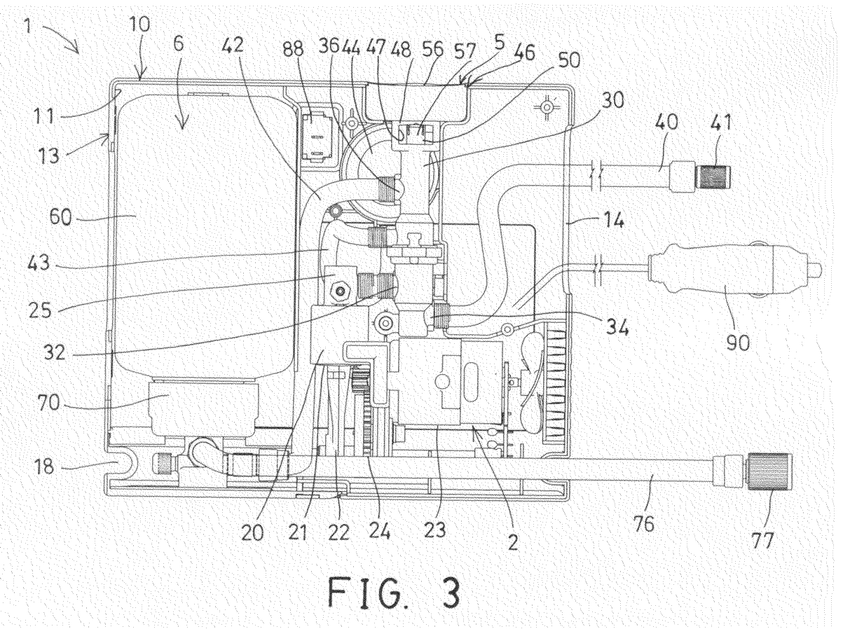

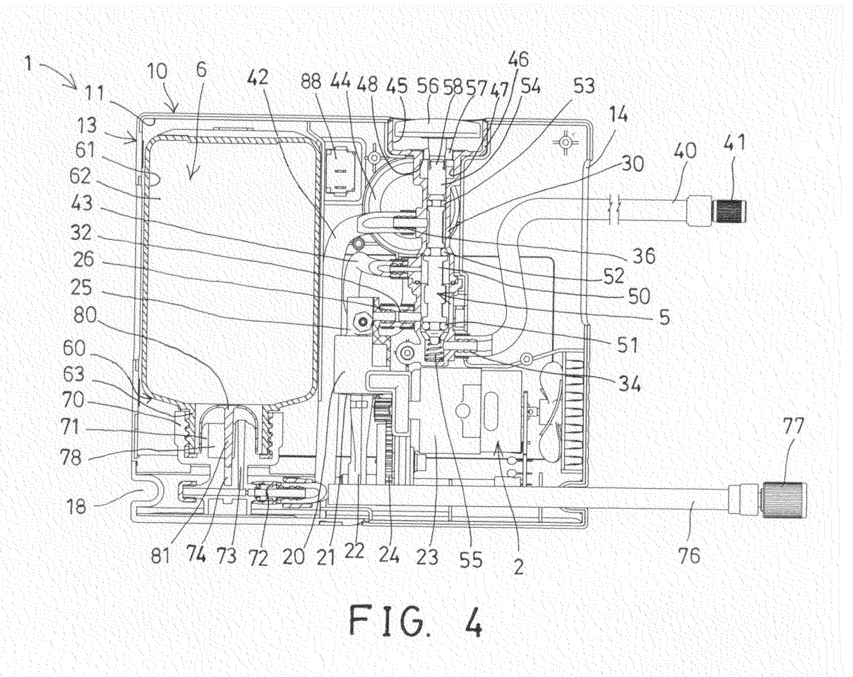

As shown in FIGS. 3-6, an air compressing device 2 includes a cylinder housing 20 received and attached and secured in the chamber 11 of the receptacle 10, a piston 21 (FIGS. 3, 4) slidably engaged in the cylinder housing 20, a piston rod 22 attached or secured to or extended from the piston 22, and a motor 23 attached and secured to the cylinder housing 20 and coupled to the piston rod 22 with an eccentric or gear coupling device 24 for moving the piston 22 relative to the cylinder housing 20 in a reciprocating action, in order to generate a pressurized air of a relatively greater air pressure and a decreased flowing quantity. One example of the typical air compressing devices is disclosed in U.S. Pat. No. 7,240,642 to Chou which may be taken as a reference for the present invention. A switch 88 is engaged in the opening 17 of the receptacle 10 and electrically coupled to the motor 23 for switching or controlling the motor 23. An electric plug or connector 90 may be extended out through the side opening 14 of the receptacle 10 (FIG. 3) and may be used to electrically couple the motor 23 to the cigarette lighter sockets of various vehicles (not shown) for energizing the motor 23.

A switching or controlling device 3 is also received and attached and secured in the chamber 11 of the receptacle 10 and coupled to the cylinder housing 20 for receiving the pressurized air from the cylinder housing 20, for example, the cylinder housing 20 includes an outlet tube 25 having an outlet port or mouth 26 for coupling to the controlling device 3 and for supplying the pressurized air to the controlling device 3. As shown in FIGS. 3-8, the controlling device 3 includes a tubular member 30 having a bore 31 formed therein, and having an inlet port 32 formed or provided on the lower portion 33 thereof and coupled to the outlet mouth 26 of the outlet tube 25 for receiving the pressurized air from the outlet tube 25 of the cylinder housing 20.

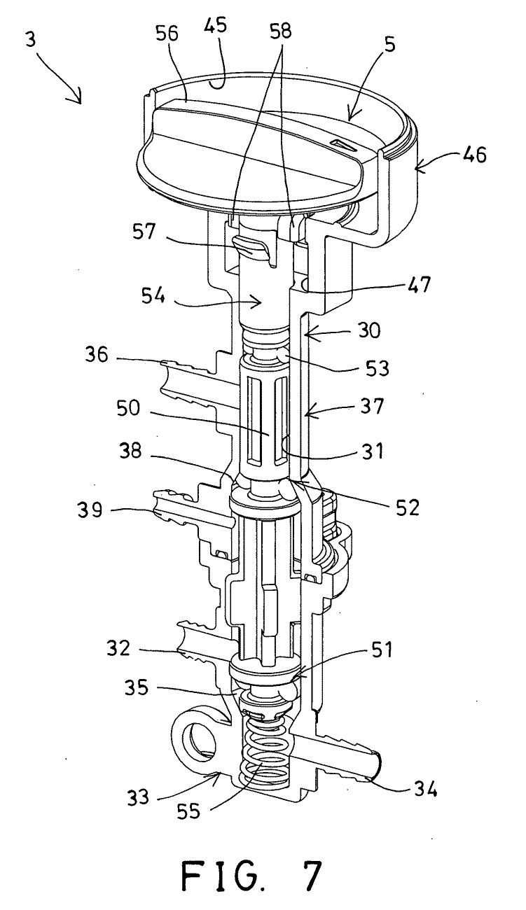

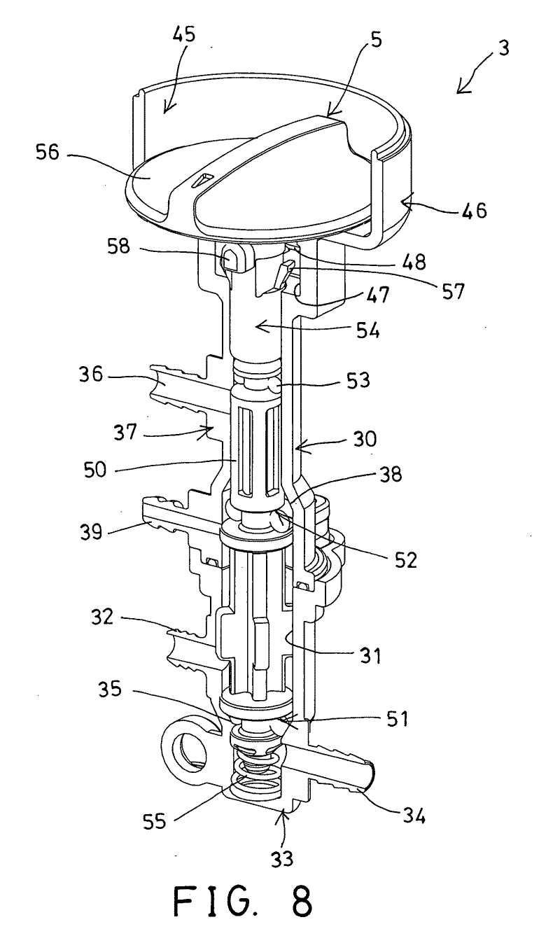

The tubular member 30 includes an outlet port 34 formed or provided on the lower portion 33 thereof and coupled to a hose 40 and/or a nozzle 41 for selectively supplying the pressurized air out through the nozzle 41 to inflate various air facilities (not shown), such as tires, air beds, air cushions, hovercrafts, etc., and includes a valve seat 35 formed or provided in the lower portion 33 of the tubular member 30 and disposed and located between the inlet port 32 and the outlet port 34 for selectively controlling and supplying the pressurized air out through the outlet port 34 and the nozzle 41 (FIG. 7), and for selectively blocking the outlet port 34 (FIG. 8) to prevent the pressurized air from flowing out through the outlet port 34 and the nozzle 41. The hose 40 and the nozzle 41 may be extended out through the side opening 14 of the receptacle 10 (FIGS. 3, 4).

The tubular member 30 further includes an exit 36 formed or provided on the middle portion 37 thereof and coupled to another hose 42 for coupling to a tire repairing device 6 which will be discussed hereinafter. Another valve seat 38 is formed or provided in the middle portion 37 of the tubular member 30 and disposed and located between the inlet port 32 and the exit 36 for selectively controlling and supplying the pressurized air out through the exit 36 and to the tire repairing device 6 (FIG. 8), and for selectively blocking the exit 36 (FIG. 7) to prevent the pressurized air from flowing out through the exit 36 and then to the tire repairing device 6, such that the controlling device 3 may be used to control and to selectively supply the pressurized air out through either the nozzle 41 or tire repairing device 6.

The tubular member 30 further includes a mouth 39 formed or provided in the middle portion 37 of the tubular member 30 and communicating with the bore 31 of the tubular member 30 and coupled to another hose 43 and/or a pressure gauge 44 for detecting and displaying or indicating the air pressure in the bore 31 of the tubular member 30, in which the pressure gauge 44 may be engaged in the opening 16 of the receptacle 10 (FIG. 1) for being viewed by the users. A valve device 5 includes a valve stem 50 slidably received and engaged in the bore 31 of the tubular member 30, and having a first or lower sealing ring or valve member 51 for selectively engaging with the valve seat 35 of the tubular member 30 and for selectively blocking the outlet port 34 of the tubular member 30 (FIG. 8) and to prevent the pressurized air from flowing out through the outlet port 34 and the nozzle 41.

The valve stem 50 further includes a second or upper or middle sealing ring or valve member 52 for selectively engaging with the other valve seat 38 of the tubular member 30 and for selectively blocking the exit 36 (FIG. 7) and to prevent the pressurized air from flowing out through the exit 36 and then to the tire repairing device 6. A sealing ring 53 is attached and secured to the upper portion 54 of the valve stem 50 and disposed and located above or upper than the exit 36 for making an air tight seal between the upper portion 54 of the valve stem 50 and the upper portion of the tubular member 30 and for preventing the pressurized air from flowing out through the upper portion of the tubular member 30.

A spring member 55 is disposed and engaged in the lower portion 33 of the tubular member 30 and engaged with the lower portion of the valve stem 50 for biasing or forcing the valve member 52 of the valve stem 50 to engage with the other valve seat 38 of the tubular member 30 and to block the exit 36 (FIG. 7) and to prevent the pressurized air from flowing out through the exit 36 and then to the tire repairing device 6. A knob 56 is provided on the upper portion 54 of the valve stem 50 and slidably engaged in an upper compartment 45 of an upper casing 46 of the tubular member 30 for depressing or moving the valve stem 50 downwardly against or onto the spring member 55 and for forcing or moving the valve member 51 of the valve stem 50 to engage with the valve seat 35 of the tubular member 30 and to block the outlet port 34 of the tubular member 30 (FIG. 8). The casing 46 is engageable in the opening 15 of the receptacle 10.

The tubular member 30 further includes a narrowed space 47 formed or provided in the lower portion of the casing 46 and located below the compartment 45 of the casing 46 and having an inner diameter or width or dimension smaller than that of the compartment 45 of the casing 46, and one or more (such as two) stops 48 oppositely extended into the casing 46, and located between the space 47 and the compartment 45 of the casing 46 (FIGS. 3, 4). The tubular member 30 includes one or more (such as two) latches 57 oppositely and outwardly and upwardly extended from the upper portion 54 thereof and engaged in the space 47 of the casing 46 for being biased to engage with the stops 48 by the spring member 55 and for limiting the valve stem 50 to slide relative to the tubular member 30.

The tubular member 30 further includes one or more (such as two) protrusions 58 oppositely extended from the upper portion 54 thereof and located above the latches 57 and arranged beside the latches 57 for allowing the latches 57 and the protrusions 58 to be arranged or formed as a cross-shaped structure, and the protrusions 58 are engaged between the stops 48 and movable downwardly beyond the stops 48 when the valve stem 50 is depressed or moved against or onto the spring member 55 with the knob 56 and engageable with the stops 48 when the valve stem 50 is rotated relative to the tubular member 30 for about ninety (90) degrees, in order to maintain the valve member 51 of the valve stem 50 in engagement with the valve seat 35 of the tubular member 30 and so as to close or to block the outlet port 34 of the tubular member 30 (FIG. 8).

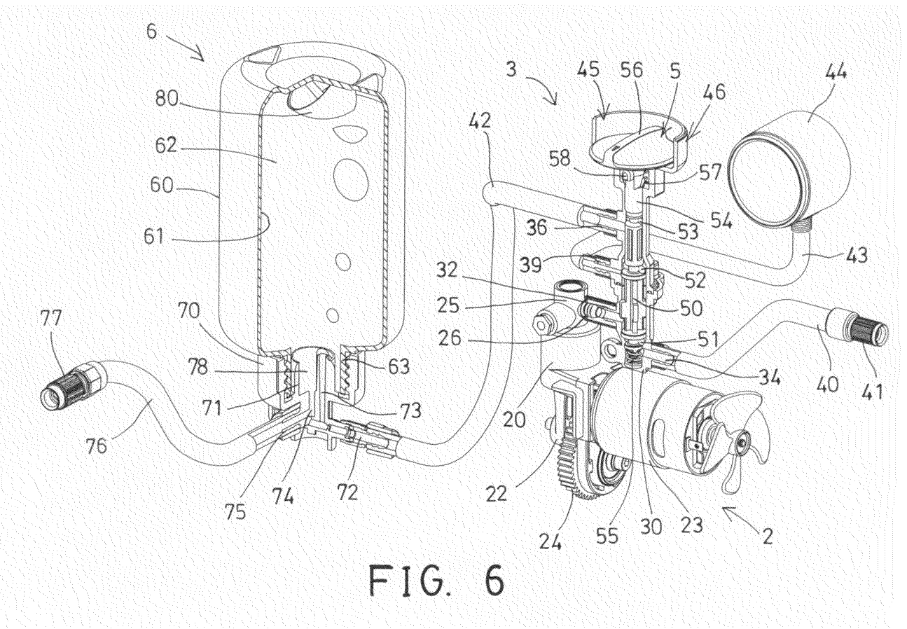

As shown in FIGS. 3-6, the tire repairing device 6 includes a container 60 received and attached and secured in the chamber 11 of the receptacle 10, and having a chamber 61 formed therein for receiving a sealing mixture or repair liquid 62. A cap 70 is attached and secured or threaded or engaged with the mouth 63 of the container 60, and includes an insert or block 71 extended or engaged into the mouth 63 of the container 60, and includes an inlet port 72 coupled to the hose 42 and the exit 36 of the tubular member 30 for selectively receiving the pressurized air from the tubular member 30, and includes an inlet passage 73 formed therein and communicating with the inlet port 72 for allowing the pressurized air to selectively flow into the chamber 61 of the container 60 (FIG. 6).

The cap 70 further includes an outlet passage 74 formed therein and offset from the inlet passage 73 of the cap 70, and communicating with an outlet port 75 which is then coupled to another hose 76 and/or a nozzle 77 for allowing the pressurized air to blow or to force the repair liquid 62 in the container 60 to flow out through the outlet passage 74 and the outlet port 75 and the hose 76 and the nozzle 77 which may be coupled to various air facilities (not shown) for selectively supplying the repair liquid 62 into the air facilities. As shown in FIG. 2, the hose 76 and the nozzle 77 may be wound and received and engaged or stored in the peripheral recess 18 of the receptacle 10. It is preferable that the cap 70 further includes a compartment 78 formed therein, particularly formed in the lower portion thereof and communicating with the outlet passage 74 for allowing the repair liquid 62 to be completely flown out of the container 60.

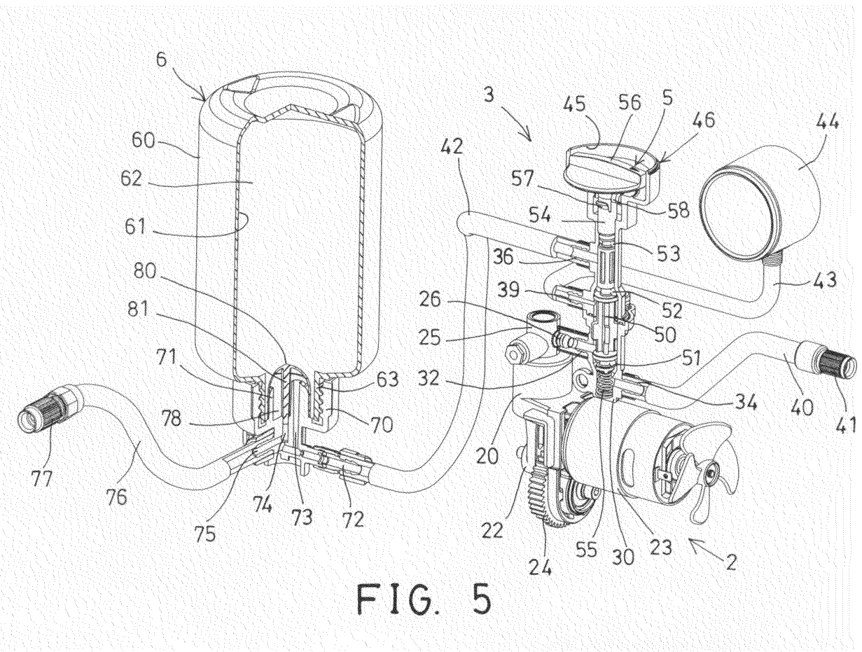

A lid 80 is further provided and engaged onto the block 71 for selectively closing or sealing or shielding the outlet passage 74 and the inlet passage 73 and the compartment 78 of the cap 70 (FIGS. 4, 5), and for suitably retaining the repair liquid 62 in the container 60 and for preventing the repair liquid 62 contained in the container 60 from flowing out through the outlet passage 74 and the outlet port 75 of the cap 70. It is preferable that the lid 80 includes a catch 81 extended therefrom for engaging into or with the outlet passage 74 of the cap 70 and for detachably attaching or securing the lid 80 to the block 71 of the cap 70, and arranged for allowing the lid 80 to be disengaged from the block 71 and to be blown into the chamber 61 of the container 60 (FIG. 6) when the pressurized air is selectively supplied into the inlet port 72 and the inlet passage 73 of the cap 70.

In operation, as shown in FIGS. 4-5 and 7, when the knob 56 has not been depressed or moved against or onto the spring member 55 by the user, the spring member 55 may bias and force the valve member 52 of the valve stem 50 to engage with the valve seat 38 of the tubular member 30 and to block the exit 36 and to prevent the pressurized air from flowing out through the exit 36 and then to the tire repairing device 6, and simultaneously, the valve member 51 of the valve stem 50 may be disengaged from the valve seat 35 of the tubular member 30 for allowing the pressurized air from the outlet tube 25 of the cylinder housing 20 to selectively flow into the inlet port 32 of the tubular member 30 and then to selectively flow out through the outlet port 34 and the nozzle 41 to inflate various air facilities.

When it is required to repair various air facilities, particularly the faulty tire, as shown in FIGS. 6 and 8, the valve stem 50 may be depressed or moved against or onto the spring member 55 with the knob 56 in order to engage the valve member 51 of the valve stem 50 with the valve seat 35 of the tubular member 30 and to block the outlet port 34 of the tubular member 30, and simultaneously, the other valve member 52 of the valve stem 50 may be disengaged from the valve seat 38 of the tubular member 30 for allowing the pressurized air to selectively flow out through the exit 36 and then to the tire repairing device 6.

When the pressurized air is selectively supplied into the inlet port 72 and the inlet passage 73 of the cap 70, as shown in FIG. 6, the pressurized air may disengage the lid 80 from the block 71 and may blow the lid 80 into the chamber 61 of the container 60, and then may blow and force the repair liquid 62 in the container 60 to flow out through the outlet passage 74 and the outlet port 75 and the hose 76 and the nozzle 77 and to repair and to inflate the faulty tire simultaneously. The controlling device 3 may thus be coupled between the air compressing device 2 and the container 60 of the tire repairing device 6 for switching or actuating the pressurized air to selectively flow out through the outlet port 34 and the nozzle 41, or to selectively flow into the container 60 of the tire repairing device 6 and to selectively blow and force the repair liquid 62 out of the container 60.

Accordingly, the air compressor and tire repairing combination includes a control device switching or actuating an air compressing device or compressor to generate and supply an air flow or a pressurized to inflate various tires or air facilities, and for selectively switching or actuating and injecting a repair liquid into the faulty tire and to repair and to inflate the faulty tire simultaneously.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An air compressor and tire repairing combination comprising:
an air compressing device for generating and supplying a pressurized air, and including an outlet tube for supplying out the pressurized gas,
a tire repairing device including a container having a chamber formed therein for receiving a repair liquid and for selectively supplying the repair liquid to a faulty tire, and
a controlling device including a tubular member having a bore formed therein, and having an inlet port coupled to said outlet tube of said air compressing device for receiving the pressurized air from said outlet tube of said air compressing device, and having an outlet port coupled to a nozzle for selectively supplying the pressurized air out through said nozzle, and having an exit coupled to said container for selectively supplying the pressurized air to said container and to selectively force the repair liquid to flow out of said container.

2. The air compressor and tire repairing combination as claimed in claim 1, wherein said tubular member includes a valve seat provided in said tubular member and disposed between said inlet port and said outlet port of said tubular member for selectively controlling and supplying the pressurized air out through said outlet port and said nozzle.

3. The air compressor and tire repairing combination as claimed in claim 2, wherein said controlling device includes a valve stem slidably received and engaged in said bore of said tubular member and having a valve member for selectively engaging with said valve seat of said tubular member and for selectively blocking said outlet port of said tubular member.

4. The air compressor and tire repairing combination as claimed in claim 1, wherein said tubular member includes a valve seat provided in said tubular member and disposed between said inlet port and said exit of said tubular member for selectively controlling and supplying the pressurized air out through said exit and said container of said tire repairing device.

5. The air compressor and tire repairing combination as claimed in claim 4, wherein said controlling device includes a valve stem slidably received and engaged in said bore of said tubular member and having a valve member for selectively engaging with said valve seat of said tubular member and for selectively blocking said exit of said tubular member.

6. The air compressor and tire repairing combination as claimed in claim 5, wherein said controlling device includes a spring member engaged with said valve stem for biasing and forcing said valve member of said valve stem to engage with said valve seat of said tubular member and to block said exit of said tubular member.

7. The air compressor and tire repairing combination as claimed in claim 6, wherein said tubular member includes a stop, and said valve stem includes a protrusion extended from said valve stem and engageable with said stop when said valve stem is depressed onto said spring member and when said valve stem is rotated relative to said tubular member, in order to maintain said valve member of said valve stem in engagement with said valve seat of said tubular member.

8. The air compressor and tire repairing combination as claimed in claim 7, wherein said valve stem includes a latch extended from said valve stem and engageable with said stop for limiting said valve stem to slide relative to said tubular member.

9. The air compressor and tire repairing combination as claimed in claim 7, wherein said tubular member includes a compartment formed in an upper casing, and a knob is provided on top of said valve stem and slidably engaged in said compartment of said casing of said tubular member for depressing and moving said valve stem onto said spring member.

10. The air compressor and tire repairing combination as claimed in claim 9, wherein said casing includes a space formed therein for selectively receiving said protrusion of said valve stem, and said stop is extended into said casing and located between said space and said compartment of said casing.

11. The air compressor and tire repairing combination as claimed in claim 1, wherein said air compressing device includes a cylinder housing, a piston slidably engaged in said cylinder housing, a piston rod extended from said piston, and a motor attached to said cylinder housing and coupled to said piston rod with a coupling device for moving said piston relative to said cylinder housing in a reciprocating action, in order to generate the pressurized air.

12. The air compressor and tire repairing combination as claimed in claim 1, wherein said tubular member includes a mouth communicating with said bore of said tubular member and coupled to a pressure gauge for detecting an air pressure in said bore of said tubular member.

13. The air compressor and tire repairing combination as claimed in claim 1, wherein said container includes a mouth, a cap is attached to said mouth of said container and includes a block engaged into said mouth of said container, and includes an inlet port coupled to said exit of said tubular member for selectively receiving the pressurized air from said tubular member, and includes an inlet passage formed therein and communicating with said inlet port for allowing the pressurized air to selectively flow into said chamber of said container.

14. The air compressor and tire repairing combination as claimed in claim 13, wherein said cap includes an outlet passage formed therein and offset from said inlet passage of said cap and communicating with an outlet port which is coupled to a nozzle for allowing the pressurized air to force the repair liquid in said container to flow out through said outlet passage and said outlet port and to flow to said nozzle.

15. The air compressor and tire repairing combination as claimed in claim 14, wherein a lid is engaged onto said block of said cap for selectively closing said outlet passage and said inlet passage of said cap and for preventing the repair liquid from flowing out through said outlet passage and said outlet port of said cap.

16. The air compressor and tire repairing combination as claimed in claim 15, wherein said lid includes a catch extended therefrom for engaging with said outlet passage of said cap and for detachably attaching said lid to said block of said cap, and said lid is disengageable from said block and movable into said chamber of said container when the pressurized air is supplied into said inlet port and said inlet passage of said cap.

17. The air compressor and tire repairing combination as claimed in claim 14, wherein said cap includes a compartment formed therein and communicating with said outlet passage of said cap for allowing the repair liquid to be completely flown out of said container.

18. The air compressor and tire repairing combination as claimed in claim 1, wherein a receptacle is further provided and includes a chamber formed therein for receiving said air compressing device and said tire repairing device and said controlling device.
